(19) United States
(12) Patent Application Publication
(10) Pub. No.: US 2001/0005417 A1
(43) Pub. Date: Jun. 28, 2001

(54) Acoustic devices

(76) Inventor: Bijan Djahansouzi, London (GB)

Correspondence Address: Alan I. Cantor, FOLEY & LARDNER, Washington Harbour, 3000 K Street, N.W., Suite 500, Washington, DC, 20007-5109, US

(21) Appl. No.: 09/737,820

(22) Filed: Dec. 18, 2000

Related U.S. Application Data
(60) Provisional application No. 60/171,115, filed on Dec. 16, 1999.

(30) Foreign Application Priority Data
Dec. 16, 1999 (GB) 9929731.9

(51) Int. Cl. H04R 25/00

(52) U.S. Cl. 381/152; 381/174

(57) ABSTRACT

A panel-form bending wave loudspeaker comprising a panel (30) having a neutral plane (50) and a displacement transducer (46, 48) coupled the panel at a position displaced from the neutral plane (50). A pair of such displacement transducers (46, 48) may be oppositely disposed about the neutral plane and may be embedded in the panel (30). The displacement transducers (46, 48) induce local bending in the panel by inducing extension and compression on opposite sides of the neutral plane (50).

This application claims the benefit of provisional application No. 60/171,115, filed Dec. 16, 1999.

### TECHNICAL FIELD

The invention relates to acoustic devices, e.g. loudspeakers and microphones, and more particularly to bending wave panel-form acoustic devices.

### BACKGROUND ART

It is a known effect of piezoelectric elements that they change dimensions in response to an applied voltage. Usually such elements are plate-like and are fixed in face-to-face contact to a length-stable substrate, e.g. a thin brass sheet. The length-changing property of such a piezoelectric element fixed to a length-stable substrate causes the substrate to bend on application of a voltage to the piezoelectric element. Such devices are known as “bender transducers.” Where the piezoelectric element is not fixed to a length-stable substrate, it is free to operate as a length-changing or “displacement” transducer device.

The operation of a bending wave panel-form loudspeaker involves the introduction of bending waves into the panel by means of a vibration transducer. A so-called “distributed mode” loudspeaker is a particular type of bending wave panel-form loudspeaker, as described in International patent application WO97/09842, and U.S. counterpart application Ser. No. 08/707,012, filed Sep. 3, 1996 (the latter being incorporated herein by reference in its entirety). A distributed mode loudspeaker has a resonant panel, and a vibration transducer is coupled at a preferred drive location on the panel to excite as wide a range of natural bending wave modes as possible.

Bending waves can be excited in a loudspeaker panel by the use of inertial transducers, and these transducers can be either electrodynamic in nature or involve the use of piezoelectric material. Several such transducers of both types are known. In the majority of cases, these transducers are fixed to the outside of the panel to bend the panel cross-section locally. For example, as shown in FIG. 1a, a piezoelectric bender transducer (10) is mounted on a surface of a composite panel having a core (12) sandwiched between two skins (14). The bender transducer (10) has a piezoelectric element (11) bonded to a metal plate (13) which is mounted on the surface of the panel.

Transducers located within the panel itself have also been proposed and operate in a similar mode. Takaya U.S. Pat. No. 4,969,197 (assigned to Murata Mfg.) discloses examples of panel-form loudspeakers with internal transducers, one of which is shown in FIG. 1c. In this arrangement the panel is made up of two half-panels that are joined together along what becomes the panel's geometric central plane (24). A piezoelectric bender device (18) is disposed at he central plane (24) in a closed cavity (26) in the panel. The bender device (18) has a metal plate (19) sandwiched between two piezoelectric elements (21), and is attached to the panel via posts (23) at the centre of the bender device. The unsupported periphery of the bender device (18) freely vibrates in the cavity (26).

Takaya U.S. Pat. No. 4,969,197 also describes as “prior art” the arrangement shown in FIG. 1b, in which a piezoelectric bender device (18) is moulded integrally in the core (20) of a foam plastic panel (22) at central plane (24). Here the piezoelectric bender device is arranged to be fully in contact with the panel over the full surface of the bender device. The bender device (18) has a metal plate (19) sandwiched between two piezoelectric elements (21).

### SUMMARY OF THE INVENTION

According to one aspect the invention is a panel-form bending wave acoustic device (e.g., loudspeaker or microphone) comprising a panel having opposed faces and a neutral plane between the faces, and at least one displacement transducer coupled to one face of the panel. Another such displacement transducer may be coupled to the opposite face of the panel. In the latter case, if the device is to be operated as a loudspeaker, the displacement transducers are driven in anti-phase. The term “neutral plane” means the plane in the panel in which there is substantially no tension or compression as the panel bends, i.e., the plane of zero strain.

According to another aspect the invention is a panel-form bending wave acoustic device (e.g., loudspeaker or microphone) comprising a panel having a neutral plane, and at least one displacement transducer embedded in the panel at a position displaced from the neutral plane. A pair of displacement transducers may be oppositely disposed about and displaced from the neutral plane. In the latter case, if the device is to be operated as a loudspeaker, the displacement transducers are driven in anti-phase. The panel may comprise a core sandwiched between two skins, with the or each transducer embedded in the core.

Preferably the or each displacement transducer is disposed adjacent to the neutral plane. Especially considering the low frequency range where associated bending displacements will be significant, the transducer is preferably positioned as close as possible to the neutral plane, i.e. immediately adjacent to the neutral plane.

Embedded transducer arrangements have the advantage that they lead to an embedded type of transduction or mechanical coupling from the transducer through the panel to a surface of the panel. Furthermore, since the means of transduction is located near the neutral plane, any undesirable stiffening and inertia contribution from the transducer to the panel is kept to a minimum, unlike that of transducers which are mounted on outer surfaces of the panel.

Foam polymer cores may have insufficient shear strength to support the mechanical coupling towards higher frequencies. In such constructions a motion coupler may be included in the panel constructions to optimise the performance. Thus, the or each displacement transducer may be coupled to the panel via a motion coupler that is coupled to the panel. The motion coupler may be coextensive with or extend beyond the area of the transducer. For a composite panel, the or each displacement transducer embedded in the core may be coupled to the skins via a motion coupler embedded in the core. The intention is to couple shear forces from one plane to another.

Additionally the transducer, if piezoelectric, may be made as a bending device, for example by bonding it to a thin substrate of similar mechanical impedance to the piezoelectric material, e.g. a thin brass sheet. Symmetrical push/pull layers of piezoelectric material may be bonded together to create a bimorph bender with or without a substrate.

The bending action of the panel benefits from useful matching of mechanical impedance between the panel and transducer so as to maximise efficiency and sensitivity. The usual forms of relatively soft plastic resin core in a composite or a monolithic bending panel are not ideal, and a coupling section of higher shear stiffness over the region of the transducer, coupling to both faces of the transducer, may improve bandwidth and output. Shear coupling forms may be incorporated if designed to a suitably lightweight construction.

While the invention results in a convenient, even cosmetically desirable internal transducer construction this is only an incidental benefit, the main benefit being the proper and balanced/optimised coupling of low amplitude displacement and bending type transducers of high mechanical impedance to a relative lower impedance bending wave panel.

Prior art using surface bonded benders generally shows coupling to one skin only which results in a degree of shear loss in coupling to the second skin via the lightweight core. Embedded placement offers drive to the panel closer to a symmetric condition. There is an additional benefit that placement of the transducer near the neutral plane of a bending wave panel reduces the mechanical loading or stiffening which arises from direct placement on an outer face. Such local stiffening of the panel changes its bending behaviour and interacts with effective coupling bending wavelength, introducing some frequency dependency. Near neutral plane drive potentially allows wider bandwidth than the prior art forms.

Another aspect of the invention relates to a method of converting a source electrical audio signal to an acoustic output. The method comprises the steps of providing a panel capable of supporting bending waves, the panel having a neutral plane; providing a pair of displacement transducers embedded in the panel at positions oppositely disposed about and displaced from the neutral plane; and applying the source electrical audio signal to the displacement transducers so that they operate in anti-phase. As a result, tension and compression are simultaneously induced on opposite sides of the neutral plane to cause local bending of the panel.

### BRIEF DESCRIPTION OF THE DRAWING

Examples that embody the best mode for carrying out the invention are described in detail below and are diagrammatically illustrated in the accompanying drawing, in which:

FIGS. 1a to 1c are partial cross-sectional edge views of panel-form loudspeakers of the prior art;

FIG. 2a is a partial cross-sectional edge view of a first embodiment of panel-form bending wave loudspeaker according to the invention;

FIG. 2b is a partial cross-sectional edge view of a second embodiment of panel-form bending wave loudspeaker according to the invention;

FIG. 2c is a partial cross-sectional edge view of a third embodiment of panel-form bending wave loudspeaker according to the invention;

FIG. 2d is a partial cross-sectional edge view of a fourth embodiment of panel-form bending wave loudspeaker according to the invention;

FIG. 2e is a partial cross-sectional plan view of the loudspeaker of FIG. 2d, taken along line 2e-2e in FIG. 2d; and

FIG. 3 is a diagram of strain distribution in a loudspeaker panel according to the present invention.

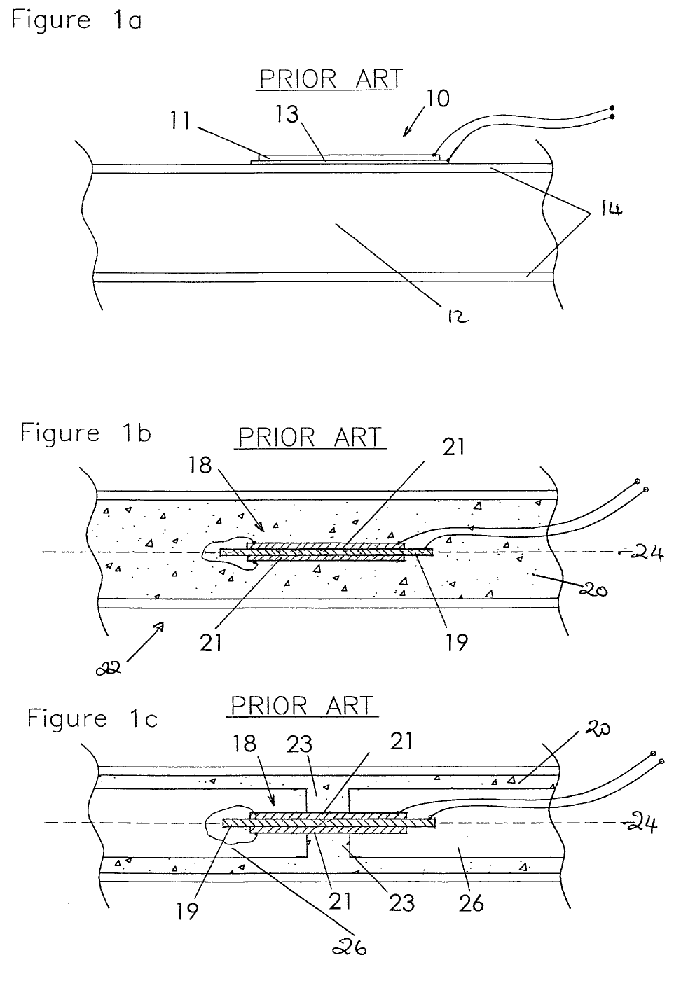

### DETAILED DESCRIPTION

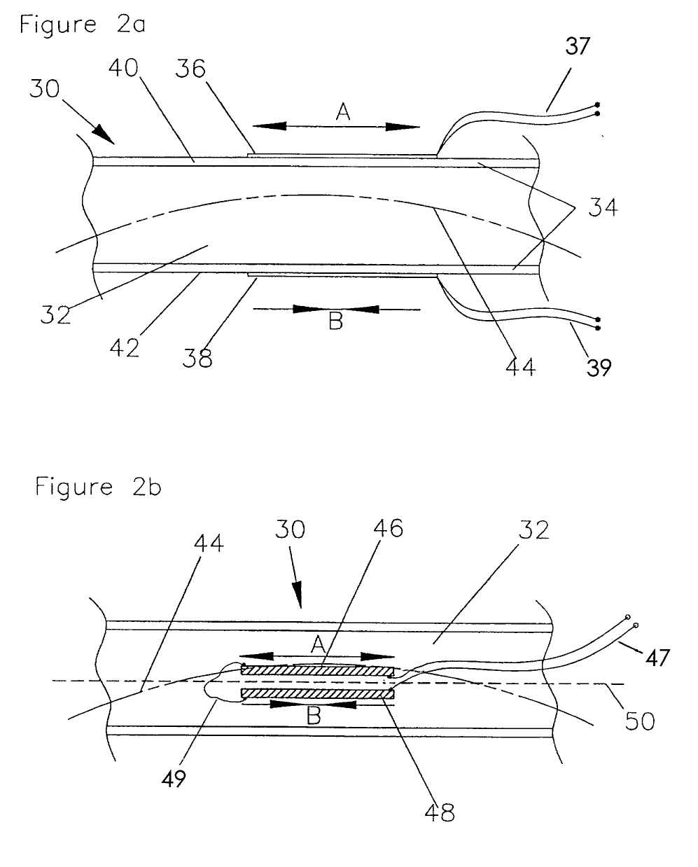

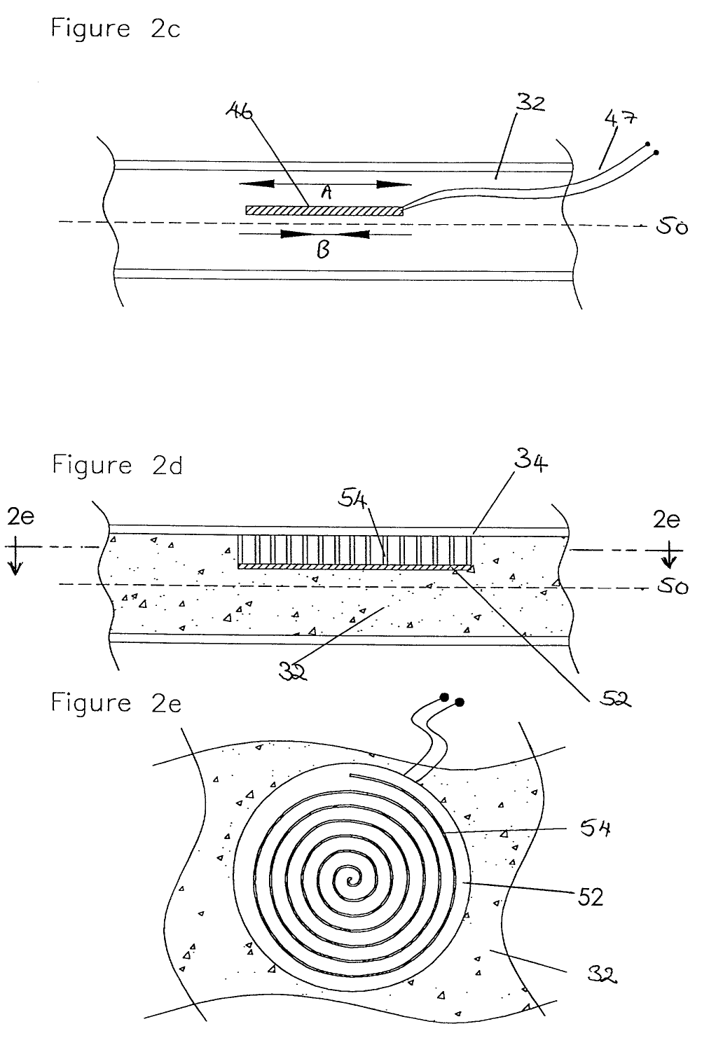

FIGS. 2a to 2e show various embodiments of a loudspeaker according to the invention in which a transducer is mounted on or within a composite panel (30) having a core (32) sandwiched between two skins (34). Although loudspeakers are described by way of example, the composite panel is suitable for sound reception as well as sound radiation using bending waves. A most preferred form employs a “distributed mode” bending wave panel with a properly located transducer, in accordance with the teachings of WO97/09842 and U.S. Ser. No. 08/707,012.

In FIG. 2a, two piezoelectric displacement transducers (36, 38) are mounted to the upper and lower faces (40, 42) of the panel (30) respectively. As explained earlier, in a piezoelectric “displacement” transducer the piezoelectric element is not fixed to a length-stable substrate, so that the piezoelectric element is free to operate as a length-changing or “displacement” transducer device.

Arrows A and B indicate the motion which the displacement transducers (36, 38) induce in the panel. The displacement transducers (36, 38) are coupled to a signal source via wires (37, 38), and are operated in anti-phase with arrow A indicating that extension is induced and arrow B that compression is induced. An exaggerated indication of the bending effect produced by this embodiment is given by the dashed line (44).

In FIG. 2b, two piezoelectric displacement transducers (46, 48) are embedded within the core (32) of the panel (30). The two displacement transducers (46, 48) are arranged symmetrically on either side of the neutral plane (50) of the panel. Embedded wires (47) connect the transducers to a signal source. Arrows A and B indicate the motion induced in the panel by the displacement transducers (46, 48), which are operatively connected (49) such that they operate in anti-phase. An exaggerated indication of the bending effect produced by this embodiment is given by the dashed line (44).

A beneficial side effect of the proposed placement of such transducers, especially with regard to resonant flat panel speakers, is that these transducers are embedded within the section, thus helping to keep the section depth to a minimum.

In FIG. 2c, only one piezoelectric displacement transducer (46) is embedded within the core (32) adjacent and above the neutral plane (50). Arrows A and B indicate the motion of the core (32) above and below the displacement transducer (46). The signal to the displacement transducer (46) is transmitted via wires (47) which are also embedded in the core (32).

Since the displacement transducers used in FIGS. 2b and 2c are constant displacement (piezoelectric) devices, only small movements are generated. Thus, placement should be as close as possible to, but not on, the neutral plane (50) to enhance effectiveness. The transducer displacement acts on the panel (30) via controlled shear in the core (32) and couples bending forces to the skins (34).

FIGS. 2d and 2e show a plate transducer (52) with wires (53) embedded within the core (32) of the panel and coupled to a skin (34) of the panel via a coupler (54) embedded in the core (32). The core is made of a foamed plastic material. The coupler (54) is in the form of a relatively lightweight spiral of foil, e.g. aluminium or stiff polymer or reinforced polymer, glued along one of its spiral edges to the skin (34) and along its other spiral edge to the transducer (52). The coupler (54) is thus orientated normal to the neutral plane (50) of the panel. Small displacements near the neutral plane generated by the plate transducer (52) are transmitted to the skin (34) via the coupler (54) with a resultant magnification of the displacement. If a pair of plate transducers (52) are used, arranged on opposite sides of the neutral plane as in the embodiment of FIG. 2b, each plate transducer (52) can be coupled to its own motion coupler for coupling to a respective skin.

Many forms of motion coupler other than the arrangement of FIGS. 2d and 2e can be envisaged. For example, a coupler for a circular piezoelectric element may comprise a series of concentric rings. For a strip or single plane element, the geometry for a shear coupler is correspondingly simplified, since radial symmetry is not required.

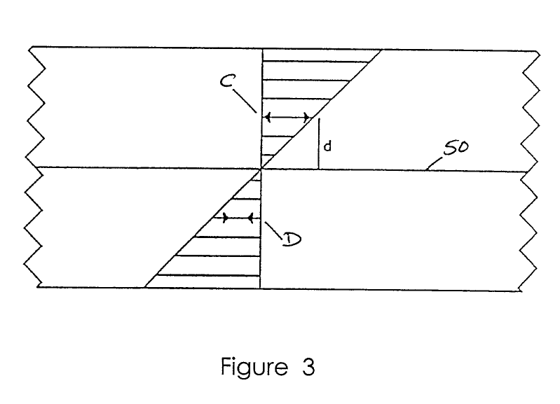

Bending gives rise to direct strains that vary linearly across the thickness of the panel. FIG. 3 shows a strain distribution within a panel in which tension and compression are simultaneously induced at either side of the neutral plane (50). Above the neutral plane (50), extension is induced as shown by arrow C and below the neutral plane (50), compression is induced as shown by arrow D. Both extension and compression reach a maximum at the outer surfaces and are zero on the neutral plane.

Bending is also dependent on the rigidity of the section. This in turn is affected by the modulus of the components making up the cross-section and their position relative to the neutral plane (i.e. distance, d). High modulus components positioned on the surface (i.e. furthest from the neutral plane), see FIG. 2a, lead to local stiffening. By placing the transducer close to the neutral plane this undesired stiffening will be minimised as will any rotary inertia effects associated with the mass of the transducers.

By positioning the displacement transducer(s) some distance from the neutral plane, the transducer displacement can act on the panel via controlled shear in the core and thus couple bending forces to the skin of the panel. It is advisable that the coupling of shear be continuous over the skin section involved to avoid wrinkling or similar distortion and to provide good coupling to the bending panel as a whole.

The core may be considered to act as a lever which magnifies the small dimensional displacement of the or each embedded transducer to a significantly larger displacement at a surface of the panel. The distance of the or each transducer from the neutral plane and the skin will determine the nature of the mechanical coupling through the core to the skins. If the or each transducer is too close to the neutral plane, there may be increased core shear and thus reduced coupling. If the or each transducer is too near the skin, the best overall matching and coupling efficiency may not be obtained.

The location of the or each transducer within the core may be adjusted to suit the or each transducer and/or the core shear properties of the panel so that loudness is balanced versus bandwidth. Generally, the neutral plane or axis for a panel may coincide with the geometric central plane or axis. By design the effective neutral plane for a particular panel, and indeed a panel section in the region of the transducer, may be moved from the nominal central plane by adjusting the physical properties of that region. For example, the core may have a density which varies with core thickness and which is not symmetrical about the centre plane. The density variation will result in varying material properties and cause a shift in the neutral plane away from the central plane.

Acoustic devices made in accordance with the invention may act as sound radiators, e.g., loudspeakers that convert an electrical signal to sound energy radiating from a panel, or as sound receptors, i.e., devices such as microphones that convert incident sound pressure waves impinging on a panel into electrical signals. Although piezoelectric displacement transducers have been disclosed, any other type of displacement transducer may be used that changes length or size to impart tension and/or compression forces to the panel substantially parallel to the neutral plane. Examples include transducers that operate on magnetostrictive, electromagnetic or electrostatic principles, micromotors, and other equivalents.

Incorporated herein by reference are UK priority application No. 9929731.9, filed Dec. 16, 1999, and U.S. provisional application No. 60/171,115, also filed Dec. 16, 1999.

1. A panel-form bending wave acoustic device comprising a panel having opposed faces and a neutral plane between said faces, and at least one displacement transducer coupled to one face of the panel.

2. A panel-form bending wave acoustic device according to claim 1, comprising a pair of displacement transducers respectively coupled to the opposed faces of the panel.

3. A panel-form bending wave acoustic device according to claim 2 in the form of a loudspeaker, further comprising a signal source adapted to drive the displacement transducers in anti-phase.

4. A panel-form bending wave acoustic device comprising a panel having a neutral plane, and at least one displacement transducer embedded in the panel at a position displaced from said neutral plane.

5. A panel-form bending wave acoustic device according to claim 4, comprising a pair of displacement transducers oppositely disposed about and displaced from said neutral plane.

6. A panel-form bending wave acoustic device according to claim 5, wherein the panel comprises a core sandwiched between two skins, and each displacement transducer is embedded in the core.

7. A panel-form bending wave acoustic device according to claim 4, wherein the panel comprises a core sandwiched between two skins, and each displacement transducer is embedded in the core.

8. A panel-form bending wave acoustic device according to claim 5, wherein each displacement transducer is disposed adjacent to said neutral plane.

9. A panel-form bending wave acoustic device according to claim 8, wherein each displacement transducer is positioned immediately adjacent to said neutral plane.

10. A panel-form bending wave acoustic device according to claim 4, wherein said at least one displacement transducer is disposed adjacent to said neutral plane.

11. A panel-form bending wave acoustic device according to claim 10, wherein said at least one displacement transducer is positioned immediately adjacent to the neutral plane.

12. A panel-form bending wave acoustic device according to claim 4, wherein said at least one displacement transducer is coupled to the panel via a motion coupler coupled to the panel and said at least one transducer.

13. A panel-form bending wave acoustic device according to claim 12, wherein the panel comprises a core sandwiched between two skins, and the motion coupler extends through said core from said at least one displacement transducer to one of said skins.

14. A panel-form bending wave acoustic device according to claim 13, wherein the motion coupler is coextensive with said at least one displacement transducer.

15. A panel-form bending wave acoustic device according to claim 14 in the form of a loudspeaker for converting an electrical signal applied to said at least one displacement transducer into acoustic energy radiated by the panel.

16. A panel-form bending wave acoustic device according to claim 14 in the form of a microphone for converting acoustic energy incident on the panel into an electrical signal produced by said at least one displacement transducer.

17. A panel-form bending wave acoustic device according to claim 14, wherein said at least one displacement transducer also is a bimorph bender.

18. A panel-form bending wave acoustic device according to claim 4, wherein the physical properties of the panel are such that the neutral plane does not coincide with the geometric central plane of the panel.

19. A panel-form bending wave acoustic device according to claim 4 in the form of a loudspeaker for converting an electrical signal applied to said at least one displacement transducer into acoustic energy radiated by the panel.

20. A panel-form bending wave acoustic device according to claim 4 in the form of a microphone for converting acoustic energy incident on the panel into an electrical signal produced by said at least one displacement transducer.

21. A panel-form bending wave loudspeaker adapted to be driven by a source signal, the loudspeaker comprising a panel having a neutral plane, and a pair of displacement transducers embedded in the panel at positions oppositely disposed about and displaced from said neutral plane, the displacement transducers being operatively connected such that they operate in anti-phase when driven by the source signal.

22. A panel-form bending wave loudspeaker according to claim 21, wherein the panel comprises a core sandwiched between two skins, and each displacement transducer is embedded in the core.

23. A panel-form bending wave loudspeaker according to claim 22, wherein each displacement transducer is disposed adjacent to said neutral plane.

24. A panel-form bending wave loudspeaker according to claim 23, wherein each displacement transducer is positioned immediately adjacent to said neutral plane.

25. A panel-form bending wave loudspeaker according to claim 21, wherein each displacement transducer is disposed adjacent to said neutral plane.

26. A panel-form bending wave loudspeaker according to claim 25, wherein each displacement transducer is positioned immediately adjacent to said neutral plane.

27. A panel-form bending wave loudspeaker according to claim 21, wherein at least one of said displacement transducers is coupled to the panel via a motion coupler coupled to the panel and said at least one transducer.

28. A panel-form bending wave loudspeaker according to claim 27, wherein the panel comprises a core sandwiched between two skins, and the motion coupler extends through said core from said at least one displacement transducer to one of said skins.

29. A panel-form bending wave loudspeaker according to claim 28, wherein the motion coupler is coextensive with said at least one displacement transducer.

30. A panel-form bending wave loudspeaker according to claim 29, wherein the physical properties of the panel are such that the neutral plane does not coincide with the geometric central plane of the panel.

31. A panel-form bending wave loudspeaker comprising a panel having a neutral plane, at least one displacement transducer embedded in the panel at a position displaced from said neutral plane, and a motion coupler embedded in the panel and coupled to the panel and said at least one displacement transducer.

32. A panel-form bending wave loudspeaker according to claim 31, wherein the panel comprises a core sandwiched between two skins, and the motion coupler extends through said core from said at least one displacement transducer to one of said skins.

33. A panel-form bending wave loudspeaker according to claim 32, wherein the physical properties of the panel are such that the neutral plane does not coincide with the geometric central plane of the panel.

34. A panel-form bending wave loudspeaker according to claim 32, wherein the motion coupler comprises a spiral of flat, thin material having opposed spiral edges, one of said spiral edges being bonded to said at least one displacement transducer and the other of said spiral edges being bonded to said one skin.

35. A method of converting a source electrical audio signal to an acoustic output comprising the steps of:
providing a panel capable of supporting bending waves, the panel having a neutral plane;
providing a pair of displacement transducers embedded in the panel at positions oppositely disposed about and displaced from the neutral plane; and
applying the source electrical audio signal to the displacement transducers so that they operate in anti-phase whereby tension and compression are simultaneously induced on opposite sides of the neutral plane to cause local bending of the panel.
